(19) United States
(12) Patent Application Publication
(10) Pub. No.: US 2006/0113270 A1
(43) Pub. Date: Jun. 1, 2006

(54) Apparatus and method for mounting baby nipple on, and in fluid communication with, valved bottle cap

(76) Inventor: Donald J. Rea, Chino Valley, AZ (US)

Correspondence Address: TOD R. NISSLE, P.C., P.O. Box 55630, Phoenix, AZ, 85078, US

(21) Appl. No.: 10/998,480

(22) Filed: Nov. 29, 2004

(51) Int. Cl. A61J 11/00; A61J 9/08

(52) U.S. Cl. 215/11.6; 215/11.1

(57) ABSTRACT

A method for a parent to safely administer formula to a baby. The method includes the step of providing a pre-packaged, pre-sterilized, self-contained, disposable safety bottle by sterilizing a container; sterilizing formula; charging the sterilized container with the sterilized formula; sealing the container; and, removably mounting a nipple assembly on the container. The nipple assembly includes a base, a nipple, and a removable cover extending over the nipple. The method also includes the steps of delivering the safety bottle to the parent; removing the nipple assembly from the container; unsealing the container; remounting the nipple assembly on the container; removing the cover; administering the formula to the baby; and, discarding the safety bottle.

This invention pertains to a method and apparatus for administering a liquid to a baby.

More particularly, the invention pertains to a method and apparatus to facilitate feeding a baby when the baby is traveling away from home.

In a further respect, the invention pertains to a method and apparatus for feeding a baby without requiring that formula be prepared by transferring formula from a storage container to a baby bottle.

In another respect, the invention pertains to a method and apparatus for reducing the risk that a baby is fed contaminated or disease laden formula or other liquids.

Most parents are unaware that it is unlikely that the formula they feed their babies is free of disease and contamination.

Bacteria and viruses inhabit counter tops, utensils, dish towels, and other items. The existence of these bacteria is one reason anti-bacterial sprays and soaps are popular. The fact is, however, that bacteria are never completely eliminated. This is evidenced in hospitals, where cases of staph are common, despite the various commonly employed sterilization measures. Further, about 30% of the population each carry staph bacteria in their nose. A particular kind of staph bacteria, called MERSA, is rapidly spreading and is resistant to most, if not all, antibiotics. MERSA has killed adults and children.

During the preparation of a bottle of formula for a baby, a can opener is utilized to open a can of liquid formula or of powdered formula. Since bacteria likely are present both on the top of the can and on the can opener, the act of opening the can introduces bacteria into the formula. The formula is then poured into a baby bottle. The baby bottle, or the disposable liner user in the baby bottle, likely has been sterilized. After the bottle was sterilized, it was placed on a dish towel or other surface. Since these surfaces contain bacteria, there is bacteria on the baby bottle. When the formula is poured through air into the baby bottle, the formula picks up contaminants in the air. The fact that the formula picks up contaminants in the air may seem insignificant. However, one concern associated with the injection with hypodermic needles of drugs into a human body is that ambient air is typically included in the hypodermic. The contaminants in the ambient air are believed possibly to adversely affect the medicine being introduced into the human body, or to affect the well-being of the individual being injected. The potential toxic affect of pollutants in the air is well documented.

By the time the formula is poured into a baby bottle, the formula likely is tainted with a variety of bacteria and contaminants, despite the well-intentioned efforts of the parent.

The baby nipple is then threaded onto the baby bottle. The baby bottle includes an externally threaded upper end. The nipple includes an internally threaded base. The nipple base is turned onto the externally threaded end of the baby bottle. The nipple is likely contaminated with bacteria. These bacteria or other contaminants can originate from the parent's hands, from a surface on which the nipple was resting, from insects, etc.

The completed baby bottle is then given to the baby, or, the parent holds the baby bottle while the infant suckles. If the completed baby bottle and the contents of the bottle are carefully examined with an electron microscope and other means, the multitude of bacteria and other contaminants present would probably astound and depress the parent.

Despite the fact that baby bottles carrying many contaminants are routinely administered to babies, the very large majority of babies survive, and apparently suffer no significant side effects. After all, each baby normally has a functioning immune system which protects the baby. The fact remains, however, that it is likely that in some instances bacteria or other contaminants contained on or in baby bottles cause injury or death to a baby, which death or injury may appear to an observer to have no discernable cause. Deadly bacteria and toxic contaminants exist that can, in very small quantities, cause serious injury to a baby, a child, or an adult.

While the common use of “sterilized” formula, baby bottles and bottle liners is useful, the use of these components in no way guarantees that a baby is fed formula that is truly sterile and free of bacteria and contaminants.

Another disadvantage of conventional procedures for feeding a baby is the number of separate steps required. Mixing and transferring formula is messy and requires a variety of implements including formula containers, nipples, baby bottles. Mothers have long coped with such problems and have successfully raised children for many years. A common and long standing complaint, however, of mothers are the many components required to feed a baby, especially when transporting the baby away from home. The size and numerous contents of baby bags are legion.

A further disadvantage of the conventional procedures for feeding babies is the likelihood that baby formula will leak or spill from storage containers or baby bottles, requiring cleaning of clothes, blankets, and bags.

Still another disadvantage of the foregoing conventional procedure for feeding babies is that during travel, a variety of implements has to be purchased at a grocery store in the event the feeding apparatus for the baby is lost or misplaced.

One possible approach for mitigating the transfer of contaminants to a baby is to provide a pre-sterilized, sealed bottle with a valved, internally threaded cap that turns on to the externally threaded neck of the bottle. The seal is located over the top of the bottle, or possibly in the valved cap. The cap is unthreaded and removed from the neck of the bottle, the seal is opened, the cap is turned back onto the neck of the bottle, and the valve in the cap is opened to permit a baby to suckle on the cap and drink fluid from the bottle. However, even though the use of a valved cap on a baby bottle is well known, such an apparatus does not appear to have been marketed. This likely is because the cost of producing such a cap is, in comparison to conventional baby nipples prohibitive.

Accordingly, it would be highly desirable to provide an improved feeding method and apparatus that would significantly reduce the likelihood that the formula administered to a baby will include harmful bacteria or contaminants, that would significantly reduce the number of separate steps required to administer formula to a baby, that would reduce the risk of formula leakage, that would simplify the administration of formula to a baby during travel, and that would not be cost prohibitive.

It would also be highly desirable to provide an improved method and apparatus for administering liquid to a baby from a sterilized, sealed bottle that is equipped with a valved cap.

Therefore, it is a principal object of the instant invention to provide an improved method and apparatus for safely administering cow's milk, soy milk, or other formula to a baby.

Another object of the invention is to provide an improved safe feeding method and apparatus for significantly reducing the likelihood that the formula given a baby includes bacteria or other contaminants.

A further object of the invention is to provide an improved safe feeding method and apparatus that greatly simplifies the steps required to administer formula to a baby.

Still another object of the invention is to provide an improved safe feeding method and apparatus that simplifies the steps required to feed a baby during travel.

Still a further object of the invention is to provide an improved method and apparatus for administering liquid to a baby from a bottle with a valved cap.

These and other, further and more specific objects and advantages of the invention will be apparent from the following detailed description thereof, taken in conjunction with the drawings, in which:

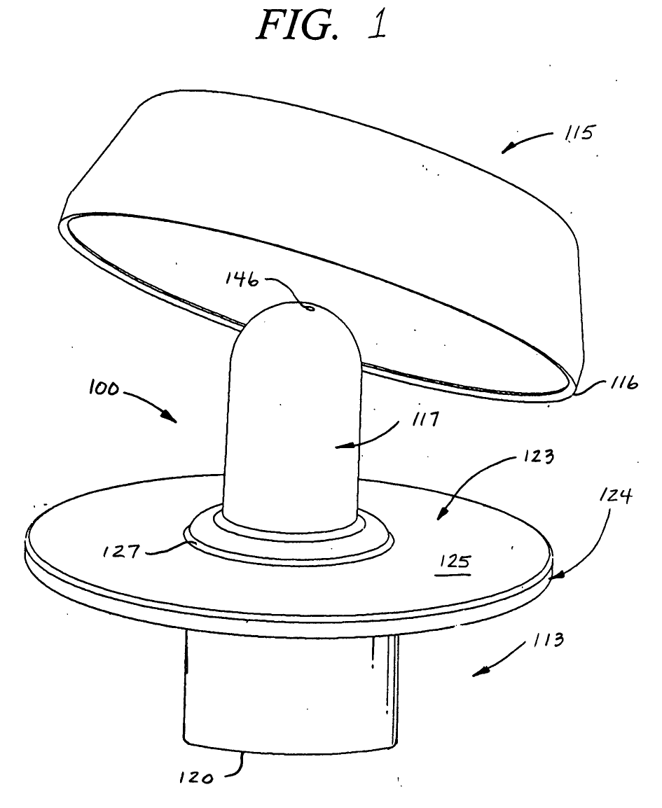

FIG. 1 is a perspective view illustrating a baby nipple adaptor constructed in accordance with the principles of the invention for use on an existing valved “sport cap”;

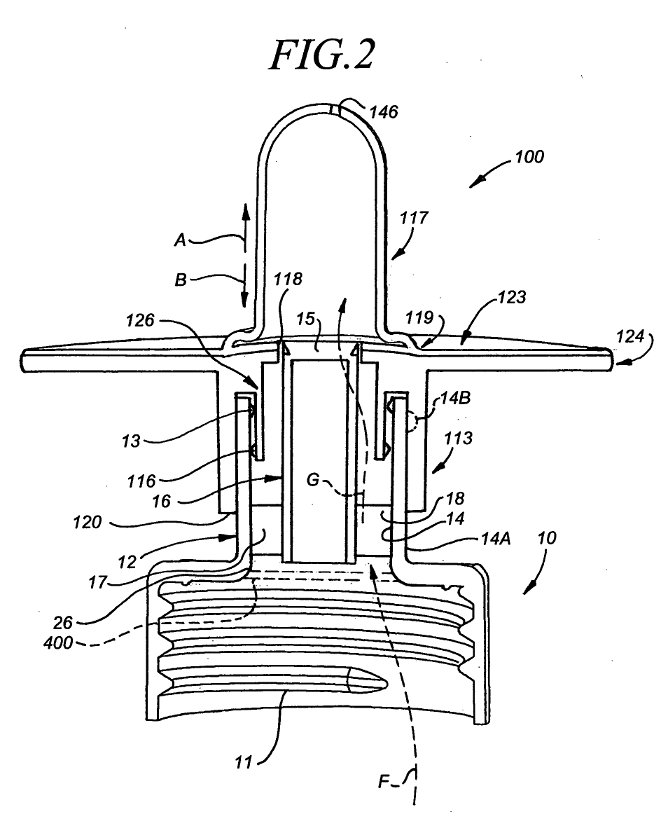

FIG. 2 is a section view illustrating the adaptor of FIG. 1 installed on a valve component of an existing “sport cap”;

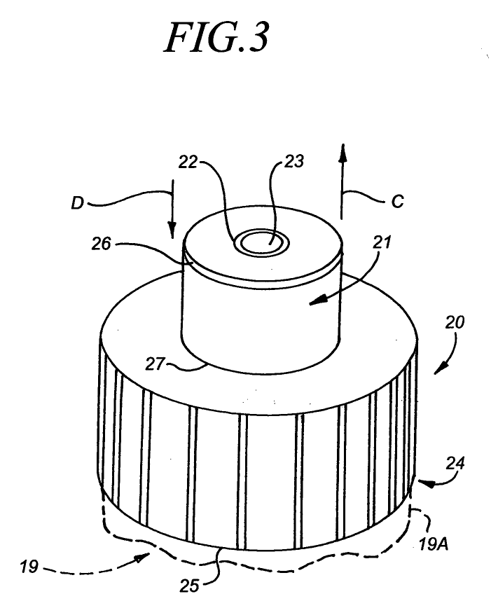

FIG. 3 is a perspective view illustrating an existing conventional valved “sport cap”;

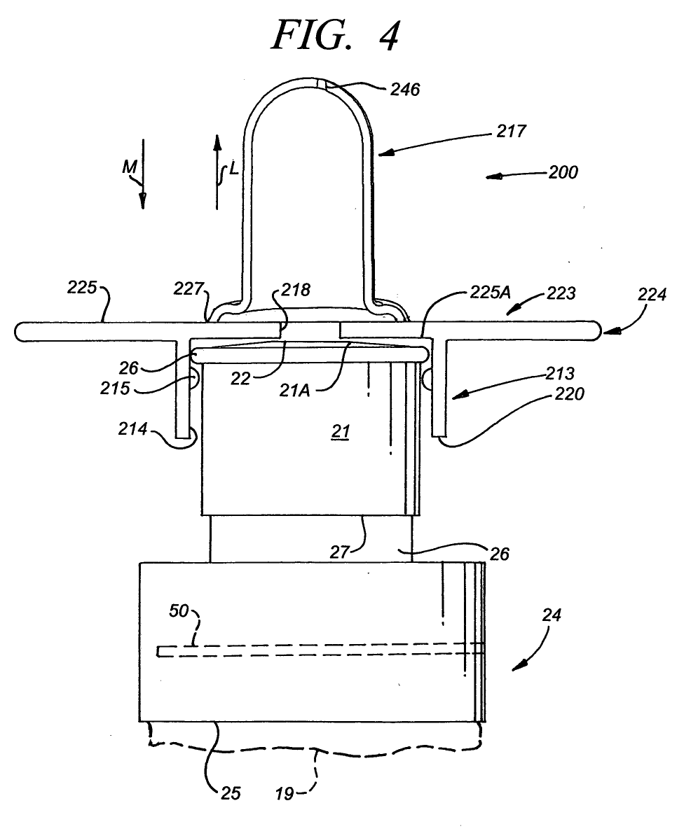

FIG. 4 is a section view illustrating a baby nipple adaptor constructed in accordance with an alternate embodiment of the invention and installed on the valved “sport cap” of FIG. 3;

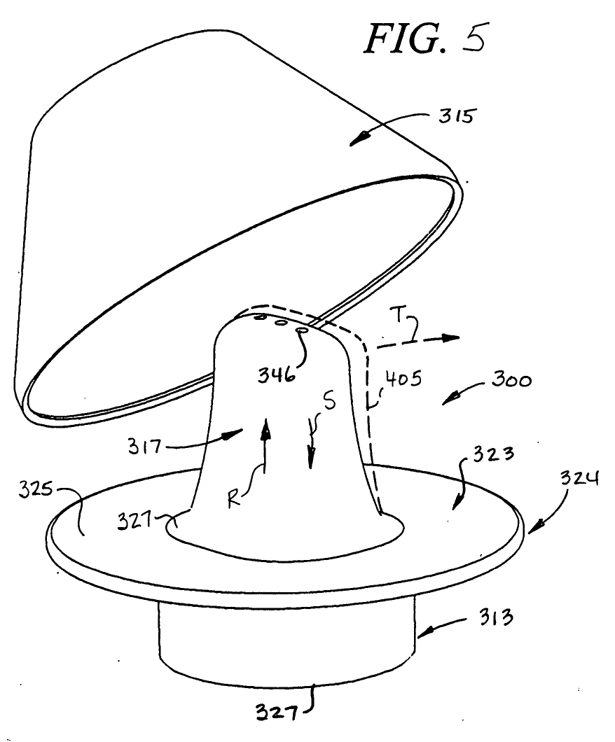

FIG. 5 is a perspective view illustrating a baby nipple adaptor constructed in accordance with still another embodiment of the invention for installation on the valved “sport cap” of FIG. 3;

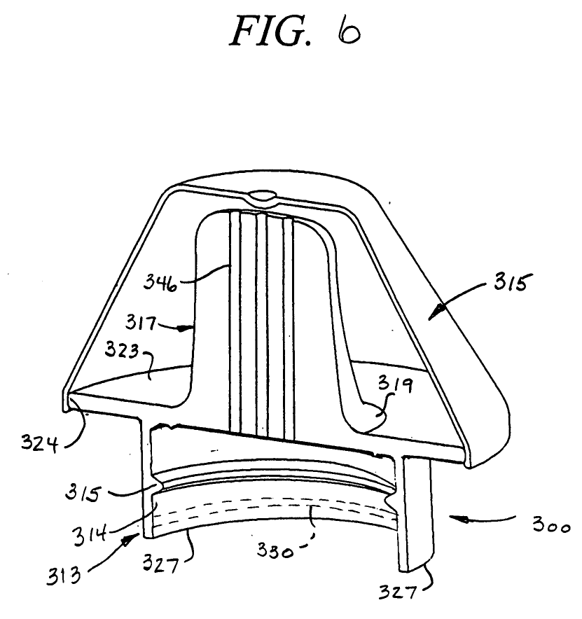

FIG. 6 is a section view of the adaptor of FIG. 5 illustrating additional construction details thereof;

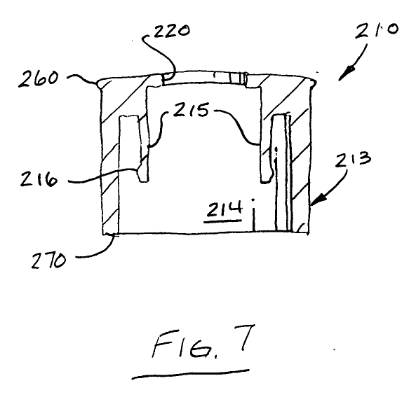

FIG. 7 is a side section view of the top of the “sport cap” of FIG. 2, the top of which is removed before the adaptor of FIG. 1 is mounted on the “sport cap”; and,

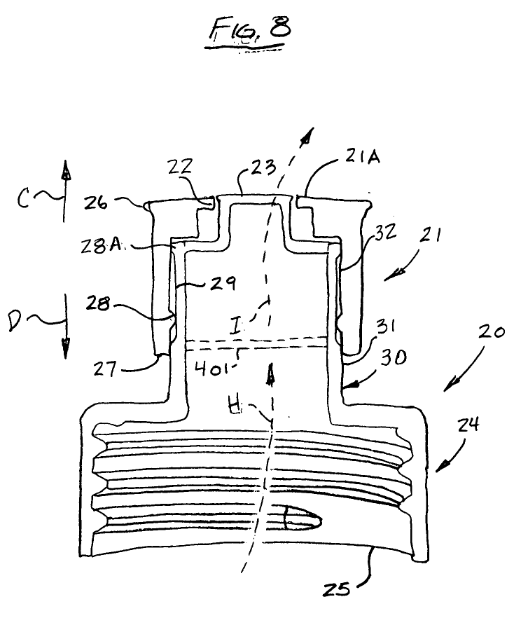

FIG. 8 is a section view of the “sport cap” of FIG. 3.

Briefly, in accordance with the invention, I provide improvements In combination with a valved bottle cap. The bottle cap includes a hollow internally threaded base shaped and dimensioned to turn on to the externally threaded neck of a bottle. The base includes an upper portion with at least one aperture formed therethrough; a hollow sleeve connected to and extending upwardly from the base; and, a top extending over the sleeve and movable between at least two operative positions on the sleeve, a first open position and a second closed position. The improvements adapt the cap to dispense liquid to a baby. The improvements includes an adaptor. The adaptor comprises a base shaped and dimensioned to fit over the top such that the base can be manually operated to open and close the top; and, a baby nipple attached to the base.

In accordance with another embodiment of the invention, I provide improvements in combination with a valved bottle cap. The cap includes a hollow internally threaded base shaped and dimensioned to turn on to the externally threaded neck of a bottle. The base includes an upper portion with at least one aperture formed therethrough. The cap also includes a hollow sleeve connected to and extending upwardly from the base; and a top extending over the sleeve. The top is movable between at least two operative positions on the sleeve, a first open position and a second closed position. The improvements adapt the cap to dispense liquid to a baby. The improvements include an adaptor. The adaptor comprises a base shaped and dimensioned to fit over the sleeve such that the base can be manually operated to open and close the bottle cap; and, a baby nipple attached to the base of the adaptor.

In a further embodiment of the invention, I provide a method for a parent to safely administer formula to a baby. The method includes the steps of providing a bottle with an externally threaded neck; and, providing a valved bottle cap. The valved cap comprises a hollow internally threaded base shaped and dimensioned to turn on to the externally threaded neck of the bottle. The base includes an upper portion with at least one aperture formed therethrough. The cap also comprises a hollow sleeve connected to and extending upwardly from the base; and, a top extending over the sleeve and movable between at least two operative positions on the sleeve, a first open position and a second closed position. The method also includes the step of providing an adaptor. The adaptor comprises a base shaped and dimensioned to be installed on and fit over the top of the cap such that said base of the adaptor can be manually operated to open and close the top; and, a baby nipple attached to the base. The method also includes the steps of installing the adaptor on the top of the cap; sterilizing the bottle; sterilizing formula; charging the sterilized bottle with the sterilized formula; sealing the bottle; threading the base of the cap onto the externally threaded neck; delivering the bottle to the parent; unthreading and removing the cap from the bottle; unsealing the bottle; threading the cap back onto the neck of the bottle; administering the formula to the baby; and, discarding the bottle.

Turning now to the drawings, which depict the presently preferred embodiments of the invention for the purpose of illustrating the practice thereof and not by way of limitation of the scope of the invention, and in which like reference characters refer to corresponding elements throughout the several views, FIGS. 1 and 2 illustrate an adaptor constructed in accordance with the invention and generally indicated by reference character 100 and including a base 113 that mounts on the upstanding, hollow, cylindrical sleeve 12 that upwardly depends from the base 10 of a conventional valved “sport cap” or similar bottle cap. The base 10 is internally threaded 11 and is shaped and dimensioned to fit on the externally threaded neck of a bottle, preferably, but not necessarily, the externally threaded neck of a conventional “PET” bottle. An aperture 26 is formed through the upper portion of base 10 and permits fluid flow communication between the base and the cylindrical sleeve 12. Sleeve 12 includes inner cylindrical surface 14 and outer cylindrical surface 14A. Circular lip 13 depends from and extends inwardly from inner surface 14. Vanes 17 and 18 interconnect inner surface 14 and hollow cylindrical sleeve 16 and maintain sleeve 16 in fixed position inside sleeve 12. Generally cylindrical top 15 of sleeve 16 is slidably received by cylindrical opening 118.

Adaptor 100 includes an outwardly radially extending cylindrical wing 123 having upper surface 125 and generally cylindrical outer edge 124. Wing 123 is shaped to be large enough to prevent the mouth of a baby from fitting over wing 123. The lips of a baby can press against surface 125 but normally are not able to fit completely around and over edge 124. Baby nipple 117 includes at least one aperture 146 shaped to permit a baby to draw liquid from a bottle and out through nipple 117 and opening 146. The material utilized to construct nipple 117 can vary but preferably comprise a soft elastomeric material. The material utilized to construct nipple 117 preferably enables the lower flange 127 of nipple 117 to be heat welded, or melted to adhere to surface 125. This is an important feature of the invention because the material utilized to fabricate wing 125 normally is a polymer that is different from the elastomer utilized to make nipple 117. The same elastomer is typically, but not necessarily, utilized to mold or otherwise produce wing 123 and sleeves 113 and 126 as a single unitary piece. The currently preferred polymer utilized to produce nipple 117 is polyolefin elastomer. The currently preferred polymer utilized to produce wing 123 and sleeves 113 and 126 is polypropylene or polyethylene. Any desired elastomers can be utilized to fabricate flange 127 and surface 125. The material utilized to fabricate flange 127 is normally, however, different from that utilized to fabricate surface 125. The materials utilized preferably permits flange 127 to be sealingly secured to surface 125 using ultrasonic bonding/welding or other heat generating techniques. Flange 127 can, if desired, conform to and extend to the periphery of surface 125. Adhesive can be utilized to secure flange 127 to surface 125.

Lip 116 extends and outwardly depends from sleeve 126.

FIG. 2 illustrates the adaptor 100 in the closed position with cylindrical top 15 in opening 118. Top 15 and opening 118 can be shaped and dimensioned such that top 15 seals, or substantially seals opening 118 when top 15 is positioned in opening 118 in the manner illustrated in FIG. 2. Adaptor 100 is moved to the open position by manually grasping edge 124 and pulling adaptor 100 upwardly in the direction of arrow A. When adaptor 100 is moved in the direction of arrow A, base 10 and sleeves 12 and 16 remain in fixed position such that opening 118 moves upwardly away from top 15 until lip 116 contacts lip 13. When lip 116 contacts lip 13, further movement in the direction of arrow A normally is prevented, unless the user wishes to completely remove adaptor 100 from sleeve 12 by forcing lip 116 over lip 13, which usually is not the case.

FIG. 7 illustrates the top 210 that normally is utilized on sleeve 12—instead of adaptor 100—to produce a sportcap. Top 210 includes cylindrical sleeves 213 and 215 that are comparable to sleeves 113 and 126, respectively. Outwardly projecting circular lip 216 on cylindrical sleeve 215 is comparable to lip 116. Aperture 220 is comparable to aperture 118. Top 210 typically also includes outwardly projecting lip 260. Lip 260 aids a user by permitting the user to better grip with his teeth or hand top 210 when the user is attempting to pull top 210 outwardly in the direction of arrow A to open a conventional sport cap (or similar bottle) that includes top 210 (instead of adaptor 100) mounted on sleeve 12.

In use of the adaptor 100, a conventional sport cap is provided consisting of top 210 mounted on sleeve 12. Top 210 is removed and discarded or set aside. Alternatively, only the “bottom” portion of a sport cap is provided. One such bottom portion is illustrated in FIG. 2 and includes base 10 and sleeves 12 and 16. The adaptor 100 is mounted on sleeve 12 by downwardly pressing adaptor 100 such that the lower end of sleeve 126 is inwardly elastically displaced to permit lip 116 to downwardly slide over lip 13. Once lip 116 slides over lip 13, the lower cylindrical end of sleeve 126 elastically moves outwardly to a position similar to that shown in FIG. 2 where sleeve 126 is generally concentric to sleeve 12. Once adaptor 100 is mounted on sleeve 12 in this fashion, adaptor 100 can be slidably displaced in the directions of arrows A and B to open and close opening 118 in the manner earlier described. When opening 118 is opened (by moving opening 118 upwardly away from top 15), fluid from a bottle on which base 10 is mounted can flow upwardly through base 10, intermediate sleeves 16 and 12, and out through opening 118 into nipple 1 17 in the manner indicated by arrows F and G. When the fluid is inside nipple 117, a baby draws the fluid out through opening 146 by sucking on nipple 117.

FIGS. 3 and 8 illustrate another conventional sport cap including a base 20, and an upstanding hollow cylindrical sleeve 30 having a top 23. A cylindrical indent 29 circumscribes the outer surface 31 of sleeve 30. Base 20 is internally threaded to be turned on to the externally threaded neck 1 9A of a bottle 19. Hollow cylindrical top 21 includes cylindrical opening 22 formed in the upper portion thereof and shaped to slidably receive top 23. Outwardly extending circular lip 26 circumscribes the upper portion of top 23. Circular lip 28 extends outwardly from inner cylindrical surface 32. Lip 28 slides along indent 29. FIGS. 3 and 8 illustrate top 21 in the closed position, with lip 28 positioned near the bottom of indent 29. Top 21 is moved to the open position by grasping edge 26 and pulling top 21 in the direction of arrow C, such that lip 28 slides upwardly along indent 29 up to the top of indent 29. When top 21 is in the open position, liquid can flow from a bottle 19 through base 20, through sleeve 30, and out through opening 22 in the manner indicated by arrows H and I in FIG. 8.

FIG. 4 illustrates an alternate adaptor constructed in accordance with the invention and generally indicated by reference character 200 and including a base 213 that mounts on the exterior of the top 21 of a conventional valved “sport cap” or similar bottle cap. In FIG. 4, cylindrical opening 218 is adjacent and above opening 22 and top 21 is in the closed position.

Adaptor 200 includes an outwardly radially extending cylindrical wing 223 having upper surface 225 and generally cylindrical outer edge 224. Wing 223 is shaped to be large enough to prevent the mouth of a baby from fitting over wing 223. The lips of a baby can press against surface 225 but normally are not able to fit completely downwardly over edge 224 and toward base 24. Baby nipple 217 includes at least one aperture 246 shaped to permit a baby to draw liquid from a bottle and out through nipple 217 and opening 246. The material utilized to construct nipple 217 can vary but preferably comprise a soft elastomeric material. The material utilized to construct nipple 217 preferably enables the lower flange 227 to nipple 217 to be heat welded, or melted, to adhere to surface 225. This is an important feature of the invention because the material utilized to fabricate wing 225 normally is a polymer that is different from the elastomer utilized to make nipple 217. Any other method or material can be utilized to secure nipple 217 to wing 223. The same elastomer is typically, but not necessarily, utilized to mold or otherwise produce both wing 223 and sleeve 213 as a single unitary piece. The currently preferred polymer utilized to produce nipple 217 is ______. The currently preferred polymer utilized to produce wing 223 and sleeve 213 is ______.

Lip 215 extends and outwardly depends from inner cylindrical surface 214 of sleeve 213.

Adaptor 200 and top 21 are moved to the open position by manually grasping edge 224 and pulling adaptor 200 and top 21 simultaneously upwardly in the direction of arrow L. When adaptor 200 is moved in the direction of arrow L, base 24 and sleeve 26 remain in fixed position and lip 215 contacts lip 26 to “pull” top 21 upwardly along with adaptor 200 in the direction of arrow L. Openings 218 and 22 and adaptor 200 and top 21 move upwardly away from top 23 until lip 28 contacts lip 28A at the top of indent 29. When lip 28 contacts lip 28A, further movement in the direction of arrow L normally is prevented, unless the user wishes to completely remove adaptor 200 from top 21 by forcing lip 215 upwardly over lip 26. Removal of adaptor 200 from top 21 usually in not intended by the user. When adaptor 200 is pressed downwardly in the direction of arrow M, surface 228A contacts and presses downwardly against upper surface 21A of top 21, generating a force that acts to downwardly displace top 21 when lip 28 is contacting lip 28A or when lip 28 is at some location along indent 29 other than the bottom of indent 29.

In use of the adaptor 200, the conventional sport cap of FIGS. 3 and 8 is provided. The adaptor 200 is mounted on top 21 by downwardly pressing adaptor 200 such that the lip 215 and sleeve 213 are outwardly elastically displaced to permit lip 215 to downwardly slide over lip 26. After lip 215 slides downwardly over and past lip 26, the cylindrical sleeve 213 and lip 215 elastically move inwardly to a position similar to that shown in FIG. 4 where sleeve 213 and lip 215 are generally concentric to cylindrical top 21. Once adaptor 200 is mounted on top 21 in this fashion, adaptor 200 and top 21 can be slidably simultaneously displaced in the directions of arrows L and M to open and close opening 22 in the manner earlier described. When opening 22 is opened (by moving top 21 and adaptor 200 simultaneously upwardly away from base 24), fluid from a bottle 19 on which base 24 is mounted can flow upwardly through base 24, through hollow sleeve 30, and out through openings 22 and 218 into nipple 217 in the manner indicated by arrows H and 1. When the fluid is inside nipple 217, a baby draws the fluid out through opening 246 by sucking on nipple 217.

FIGS. 5 and 6 illustrate an alternate adaptor constructed in accordance with the invention and generally indicated by reference character 300 and including a base 313 that mounts on the exterior of the top 21 of a conventional valved “sport cap” or similar bottle cap. When adaptor 300 is mounted on the top 21, the lower ends of openings 346 are adjacent and above opening 22.

Adaptor 300 includes an outwardly radially extending cylindrical wing 323 having upper surface 325 and generally cylindrical outer edge 324. Wing 323 is shaped to be large enough to prevent the mouth of a baby from fitting over wing 323. The lips of a baby can press against surface 325 but normally are not able to extend completely over and envelop edge 324. Baby nipple 317 includes at least one aperture 346 shaped to permit a baby to draw liquid from a bottle and out through nipple 317 and aperture 346. The material utilized to construct nipple 317 can vary but preferably comprises an elastomeric material. The material utilized to construct nipple 317 preferably enables the lower flange 327 of nipple 317 to be heat welded, or melted or softened, to adhere sealingly and permanently to surface 325. This is an important feature of the invention because the material utilized to fabricate wing 325 normally is a polymer that is different from the elastomer utilized to make nipple 317. Any other method or material can be utilized to secure nipple 317 to wing 323. The same elastomer is typically, but not necessarily, utilized to mold or otherwise produce both wing 323 and sleeve 313 as a single unitary piece. The currently preferred polymer utilized to produce nipple 317 is polyolefin. The currently preferred polymer utilized to produce wing 323 and sleeve 313 is polypropylene or polyethylene.

Lip 315 extends and outwardly depends from inner cylindrical surface 314 of sleeve 313.

Use of the adaptor 300 is similar to the use of adaptor 200. The conventional sport cap of FIGS. 3 and 8 is provided. The adaptor 300 is mounted on top 21 by downwardly pressing adaptor 300 such that the lip 315 and sleeve 313 are outwardly elastically displaced to permit lip 315 to downwardly slide over lip 26. After lip 315 slides downwardly over and past lip 26, the cylindrical sleeve 313 and lip 315 elastically move inwardly to a position where sleeve 313 and lip 315 are generally concentric to cylindrical top 21. Once adaptor 300 is mounted on top 21 in this fashion, adaptor 300 and top 21 are simultaneously displaced in the directions of arrows R and S to open and close, respectively, opening 22 in the manner earlier described with respect to the operation of the sports cap of FIGS. 3 and 8. When opening 22 is opened (by moving top 21 and adaptor 300 upwardly away from base 24), fluid from a bottle 19 on which base 24 is mounted can flow upwardly through base 24, through hollow sleeve 30, and out through openings 22 and 346 through nipple 317 in the manner indicated by arrows H and I.

The outer diameter of one top 21 and lip 26 of a sport cap construction can be different than the outer diameter of another top 210 and lip 260 of a sport cap construction. In this case, an adaptor 300 can be constructed to include one circular lip 330 that will snap over the lip 260 of a larger diameter top 21 and also to include a second circular lip 315 that will snap over the lip 26 of a smaller diameter top 210. Lip 315 has a smaller inner diameter than lip 330.

When adaptors 100, 200, 300 are utilized on a sport cap or other bottle cap that is mounted on the neck 19A of a bottle 19, the bottle 19 is typically inverted by a baby utilizing the bottle so that gravity assists the flow of liquid out of the bottle, out through the sport cap or portion thereof, and out through the adaptor 100, 200, 300.

As would be appreciated by those of skill in the art, an adaptor 100, 200, 300 can be constructed in any desired manner as long as the adaptor will mount on a sport cap, portion of a sport cap, or other valved cap such that the adaptor 100, 200, 300 can be moved between a first operative position in which liquid is prevented from flowing out of a bottle 19 or other container and through the adaptor and a second operative position in which liquid is permitted to flow out of a bottle 19 and through the adaptor 100, 200, 300. The sport caps illustrated in FIGS. 1, 2, 3, 4, 7, 8 are conventional “push-pull” caps. The invention can also be utilized on sport caps that twist, or turn, between open and closed positions.

Nipple 317 is preferably made out of a polymer that permits a baby to deform elastically and displace nipple 317 about one-half inch to either side in the manner indicated by dashed lines 405 and arrow T in FIG. 5. Nipple 317 is also, however, substantially solid such that a baby or young child can not readily bite or bend nipple 317 to constrict apertures 346 and prevent fluid from flowing through the apertures 346. In contrast, nipples 117 and 217 typically can be bitten or squeezed by the mouth of a child to prevent formula, water, juice, or some other fluid in bottle 19 from flowing out through the opening(s) 46, 146 in the nipple.

The bottle 19 can be fabricated from plastic, glass, or any other desired material. The bottle usually, but not necessarily, will be discarded after liquid in the container is consumed by a baby or child. The container is sterilized.

Milk, soy milk, or some other formula is provided. The formula is sterilized and put into the bottle 19. Water, juice, or some other fluid can also be put in bottle 19 instead of or in conjunction with formula. Water, juice, and fluids other than formula may not require sterilization, but may only require some preliminary purification steps, or pasteurization steps, etc.

The sterilized formula is put into the sterilized container. The container is sealed. One preferred way of sealing the container is by placing a circular seal over the top edge of the neck of the bottle. The seal can include a layer of aluminum or other metal laminated on paper. The seal can be constructed in any desired manner. The normal function of the seal is to prevent contaminants from entering the bottle 19 and to prevent liquid from escaping from the bottle. The seal can be peeled off the bottle when it is desired to use the bottle to feed a baby. Another way of sealing the container is to place one of the sport tops of FIGS. 1 to 4 on the neck of bottle 19 with the valve in the top in the closed position.

After the baby bottle is sealed, one of the sport cap-adaptor combinations illustrated in the drawings is mounted on the neck of the bottle 19. The sport cap-adaptor combinations preferably are sterilized so that after a cover 115, 315 is applied, the sterile nature of the nipple is preserved until cover 115, 315 is removed when bottle 19 is being used to feed a baby, or is being used by another individual.

When the bottle 19 and the sport cap-adaptor combination(s) are assembled, a pre-packaged, pre-sterilized, self-contained, disposable safety bottle is produced. The safety bottle does not require sterilization prior to use. The safety bottle need not be charged with formula or other liquid prior to use. Use of the safety bottle does not require clean up of various utensils which are commonly used to produce formula. A supply of baby bottles is not necessary. A supply of nipples is not necessary. A supply of formula is not necessary. Sterilization equipment is not necessary. Bottles, nipples, and equipment need not be stored in sealed area free from insects and chemical contaminants.

The safety baby bottles are delivered to parents by distributing the bottles to grocery stores and other outlets and by the outlets selling the safety baby bottles to parents. The parent transports purchased safety bottles to home or some other desired location. The parent unthreads base 10, 24 from the neck 19A, and peels the seal 50 off the top of the neck 19A of the bottle 19. The base 10, 24 is sealingly threaded back onto neck 19A. Protective cover 115, 315 is removed. The adaptor 100, 200, 300 is pulled (or turned) in the direction of arrow A, L, or R to displace the adaptor (and, if appropriate, the associated top 21) upwardly to open the valve in the cap. Nipple 117, 217, 317 is placed directly in the mouth of a baby or young child. After the formula or other liquid in the bottle is administered to the baby, the bottle 19 is discarded, or, if some liquid remains in the bottle, is refrigerated or otherwise stored for future consumption. If desired, bottle 19 can be resealed by downwardly displacing the adaptor 100, 200, 300 in the direction of arrow B, M, S to close the valve in the cap. This procedure for administering formula or other liquids to a baby makes it much less likely that the formula or other liquid in bottle 19 will be contaminated. The procedure also greatly simplifies traveling with a baby, because the disposable safety bottle of the invention eliminates many of the afore-mentioned problems associated with feeding a baby “on the go”.

In one preferred embodiment of the invention, the base 10, 24 is sized to fit on the 28 millimeter diameter externally threaded neck of a conventional water bottle. Such conventional bottles are readily available and widely utilized in grocery stores and other retail outlets and come in various convenient sizes.

Nipple 117, 217, 317 or any other desired portion of the bottle cap-adaptor combination and bottle 19 can be impregnated with a chemical composition that produces a scent that smells like a cherry, blueberry, or other desired fragrance. Such a fragrance can give a person drinking a fluid through the adaptor-bottle cap assembly the impression that the fluid includes cherry, blueberry, or another food associated with the fragrance. One use of such chemical compositions is set forth in U.S. Pat. No. 6,045,833.

In FIG. 6, the openings 346 formed in nipple 317 preferably, but not necessarily, permit a cumulative volume of fluid to flow out of openings 346 (when the bottle cap valve is open) which is less than that which flows out of a conventional pop-top that is currently found on water bottles and is used by adults. The combined volume of fluid which exits all of the openings 346 when the bottle cap valve is open is presently preferably, but not necessarily, equivalent to the volume of liquid which flows out of the spout on a tippee-cup top. Tippee-cup spouts typically are the next step in teaching a young child to drink. The child graduates from a baby nipple to a tippee cup spout, and then to drinking out of a glass or cup which does not have a cover. The shape and dimension of nipple 317 can vary as desired, but nipple 317 is presently shaped to fit in the mouth of a young child one to four years old. Wing 323 is shaped and dimensioned to prevent a child from getting his mouth completely over the entire wing 323.

As earlier noted, the baby/child bottles illustrated in FIGS. 1 to 7 are preferably each utilized by sterilizing or otherwise disinfecting a bottle or other container, by charging the bottle with sterile fluid, by sterilizing or otherwise disinfecting the top, by mounting the top on the bottle that was charged with fluid to seal the bottle (or by otherwise sealing the top of the bottle with a removable or puncturable seal before mounting the bottle top on the bottle), by covering the top with a sterilized or disinfected cover or plastic coating to protect the top from contamination, by selling the pre-sterilized, pre-sealed safety baby bottle to a consumer, by removing the seal protecting the baby bottle, by (if necessary) opening a valve in the top of the safety bottle, by having a young child or infant drink fluid from the bottle, and by discarding the safety bottle. This procedure greatly simplifies and improves on the safety of the age-old procedures for feeding a baby.

If desired, a resilient, pliable diaphragm 400 (FIG. 2), 401 (FIG. 8) can be utilized and inserted at any desired location in the valved bottle caps of the invention. Such diaphragms typically comprise a thin, circular, solid piece of elastomer with one or more slits cut in the elastomer. Once installed in a valved bottle cap, the diaphragm generally prevents fluid from flowing through the diaphragm until a baby sucks on the bottle cap and upwardly deflects the diaphragm to cause the slit to open to allow fluid to flow through the slit.

Having described my invention in such terms as to enable those of skill in the art to understand and use it, and having described the presently preferred embodiments and best mode thereof, I Claim:

1. In combination with a valved bottle cap including
a hollow internally threaded base shaped and dimensioned to turn on to the externally threaded neck of a bottle, said base including an upper portion with at least one aperture formed therethrough,
a hollow sleeve connected to and extending upwardly from the base, and
a top extending over the sleeve and movable between at least two operative positions on said sleeve,
a first open position, and
a second closed position,
the improvements for adapting the cap to dispense liquid to a baby, said improvements including an adaptor comprising
(a) a base shaped and dimensioned to fit over the top such that said base can be manually operated to open and close the top; and,
(b) a baby nipple attached to said base.

2. In combination with a valved bottle cap including
a hollow internally threaded base shaped and dimensioned to turn on to the externally threaded neck of a bottle, said base including an upper portion with at least one aperture formed therethrough,
a hollow sleeve connected to and extending upwardly from the base, and
a top extending over the sleeve and movable between at least two operative positions on said sleeve,
a first open position, and
a second closed position,
the improvements for adapting the cap to dispense liquid to a baby, said improvements including an adaptor comprising
(a) a base shaped and dimensioned to fit over the sleeve such that said base can be manually operated to open and close the bottle cap; and,
(b) a baby nipple attached to said base of said adaptor.

3. A method for a parent to safely administer formula to a baby, including the steps of
(a) providing a bottle with an externally threaded neck;
(b) providing a valved bottle cap comprising
(i) a hollow internally threaded base shaped and dimensioned to turn on to said externally threaded neck of said bottle, said base including an upper portion with at least one aperture formed therethrough,
(ii) a hollow sleeve connected to and extending upwardly from said base, and
(iii) a top extending over said sleeve and movable between at least two operative positions on said sleeve,
a first open position, and
a second closed position,
(b) providing an adaptor comprising
(i) a base shaped and dimensioned to be installed on and fit over said top such that said base of said adaptor can be manually operated to open and close the top; and,
(ii) a baby nipple attached to said base;
(c) installing said adaptor on said top;
(d) sterilizing said bottle;
(e) sterilizing formula;
(f) charging said sterilized bottle with said sterilized formula;
(g) sealing said bottle;
(h) threading said base of said cap onto said externally threaded neck;
(i) delivering said bottle to the parent;
(j) unthreading and removing said cap from said bottle;
(k) unsealing said bottle;
(l) threading said cap back onto said neck of said bottle;
(m) administering said formula to the baby; and,
(n) discarding said bottle.
